(19) United States
(12) Patent Application Publication
(10) Pub. No.: US 2009/0278802 A1
(43) Pub. Date: Nov. 12, 2009

(54) Mouse structure for generating encoding signals

(76) Inventor: Sheng-Hsin Liao, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,280

(22) Filed: May 6, 2009

(30) Foreign Application Priority Data
May 9, 2008 (TW) 97208074
Jun. 30, 2008 (TW) 97211608

(51) Int. Cl. G09G 5/08

(52) U.S. Cl. 345/164

(57) ABSTRACT

A mouse structure for generating encoding signals includes a main body, a turntable unit and a signal encoder. The main body has a PCB disposed therein. The turntable unit has a turntable and a movable body connected to the turntable, the turntable unit is rotatably disposed on the main body, and the movable body is projected into the main body. The signal encoder is disposed in the main body and corresponds to the turntable. The signal encoder is electrically connected with the PCB, and the movable body passes through the signal encoder. Therefore, the signal encoder would generate encoding signal to control scrolling of screen on monitor of computer by rotating the turntable.

### BACKGROUND OF THE INVENTION

1. Field of the Invention

The present invention relates to a mouse structure, in particular, to a mouse structure for generating encoding signals by rotating a plane turntable.

2. Description of Related Art

As science and technology is developed fast, the computer has already been widely applied to various kinds of information occasions, for instance commercial exchanges, word processing, computer drawing and audiovisual amusement, etc. The computer must usually utilize the peripheral control device such as mouse, trackball or touch panel etc. in order to control the movement of the cursor and scroll the screen on the monitor of the computer.

Referring to FIG. 1, the mouse has a roller 12 longitudinally pivoted on a front side of the main body 11 and a mechanical encoder 13 disposed in the main body 11. Hence, the mechanical encoder 13 can be driven by rotating the roller 12 in order to scroll screen on monitor of computer.

Referring to FIG. 2, the mouse uses an optical encoder. The mouse has a roller 12′ longitudinally pivoted on a front side of the main body 11′, a grating wheel 14′ rotated with the roller 12′, a light receiver 15′ disposed in the main body 11′ and beside the grating wheel 14′, and a light generator (not shown). Hence, the rating wheel 14′ and the roller 12′ can be rotated together, so that the light receiver 15′ can receive the light variation of the light generator in order to scroll screen on monitor of computer.

However, the roller 12 of the mechanical mouse or the roller 12′ of the optical mouse is longitudinally pivoted on the front side of the main body. Hence, the mouse needs to create a large space to receive the roller, so that the size of the mouse is increased. When the diameter of the roller is decreased, the operation feeling is bad for user. In addition, when the radius r of the roller is increased, the thickness of the mouse is increased.

Moreover, the user needs to use his/her forefinger to control the roller of the mouse, but this type of the roller is not a good design for users according to ergonomics. In addition, the user rolls the roller by a single direction for a long time, so that the forefinger would injure easily.

### SUMMARY OF THE INVENTION

In view of the aforementioned issues, the present invention provides a mouse structure for generating encoding signals. The present invention can reduce the size of the mouse by using a horizontal turntable unit and the present invention provides various operation ways in order to prevent the joint of the forefinger from injuring easily due to continual reciprocating action.

To achieve the above-mentioned objectives, the present invention provides a mouse structure for generating encoding signals, including: a main body, a turntable unit and a signal encoder. The main body has a PCB disposed therein. The turntable unit has a turntable and a movable body connected to the turntable, the turntable unit is rotatably disposed on the main body, and the movable body is projected into the main body. The signal encoder is disposed in the main body and corresponds to the turntable. The signal encoder is electrically connected with the PCB, and the movable body passes through the signal encoder.

The mouse structure further includes a plurality of touching switches and a ball-positioning device. The touching switches are disposed in the main body and electrically connected to the PCB, and the touching switches are disposed under the edge portion of the turntable. The ball-positioning device is disposed in the main body and has a plurality of balls contacted with a bottom side of the turntable.

To achieve the above-mentioned objectives, the present invention provides a mouse structure for generating encoding signals, including: a main body, a turntable unit, a linkage mechanism, a driven mechanism and a signal encoder. The main body has a PCB disposed therein. The turntable unit has a turntable and a movable body, the turntable unit is rotatably disposed on the main body, the turntable has an opening, and the movable body passes through the opening and is movably extended into an inner portion of the main body. The linkage mechanism is disposed in the main body and is connected to the turntable, and the linkage mechanism is rotated by rotating the turntable. The driven mechanism is pivotally disposed in the main body and is contacted with the linkage mechanism. The signal encoder is disposed in the main body and electrically connected with the PCB. The driven mechanism passes through the signal encoder in order to drive the signal encoder.

The mouse structure further includes a plurality of touching switches and a ball-positioning device. The touching switches are disposed in the main body and electrically connected to the PCB, and the touching switches are disposed under the edge portion of the turntable. The ball-positioning device is disposed in the main body and has a plurality of balls contacted with a bottom side of the turntable.

Therefore, the turntable is transversely disposed on the main body, so that the user can control the scrolling of the screen on the monitor of the computer by rotating the turntable. In addition, the turntable is transversely disposed on the main body, so that the vertical space of the main body is reduced in order to reduce the size of the mouse.

The present invention provides two ways to control the scrolling of the screen on the monitor of the computer. According to ergonomics, various operation ways can prevent the joint of the forefinger from injuring easily due to continual reciprocating action.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a perspective view of the mechanical mouse according to the prior art;

FIG. 2 is a perspective view of the optical mouse according to the prior art;

FIG. 3 is a perspective, exploded view of the mouse structure according to the first embodiment of the present invention;

FIG. 4 is a perspective, exploded view of the signal encoder of the mouse structure according to the present invention;

FIG. 5 is a perspective, assembled view of the first usage state of the mouse structure according to the present invention;

FIG. 6 is a perspective, assembled view of the second usage state of the mouse structure according to the present invention;

FIG. 7 is a another perspective, exploded view of the mouse structure according to the first embodiment of the present invention;

FIG. 8 is a perspective, exploded view of the mouse structure according to the second embodiment of the present invention;

FIG. 9 is a perspective, assembled view of the mouse structure according to the second embodiment of the present invention;

FIG. 10 is another perspective, exploded view of the mouse structure according to the second embodiment of the present invention;

FIG. 11 is a perspective, exploded view of the mouse structure according to the third embodiment of the present invention;

FIG. 12 is a partial, perspective, assembled view of the mouse structure according to the third embodiment of the present invention;

FIG. 13 is a perspective, assembled view of the first usage state of the mouse structure according to the third embodiment of the present invention;

FIG. 14 is a perspective, assembled view of the second usage state of the mouse structure according to the third embodiment of the present invention;

FIG. 15 is a perspective, exploded view of the mouse structure according to the fourth embodiment of the present invention;

FIG. 16 is a partial, cross-sectional, assembled view of the mouse structure according to the fourth embodiment of the present invention;

FIG. 17 is another partial, cross-sectional, assembled view of the mouse structure according to the fourth embodiment of the present invention; and

FIG. 18 is a perspective, assembled view of the mouse structure according to the present invention.

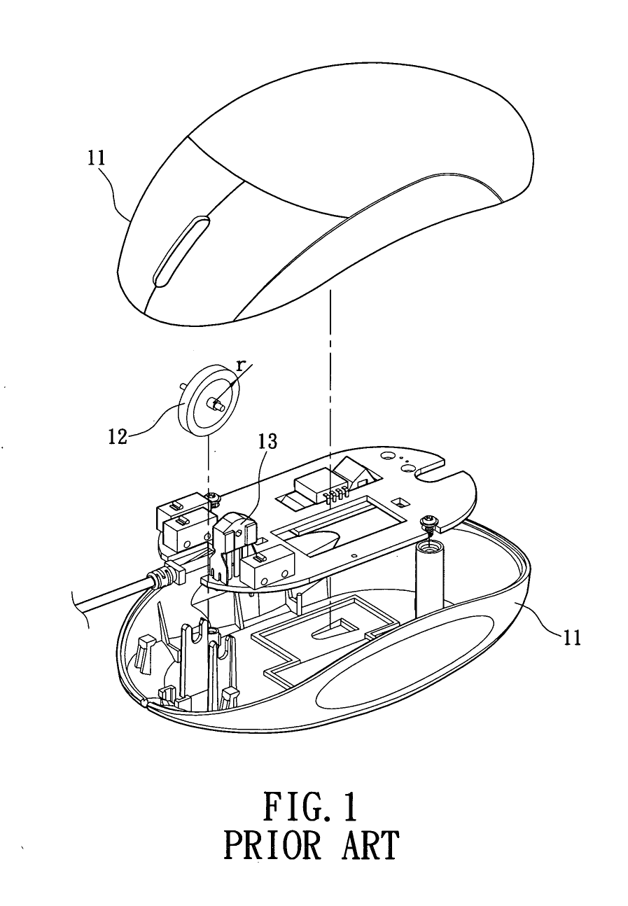

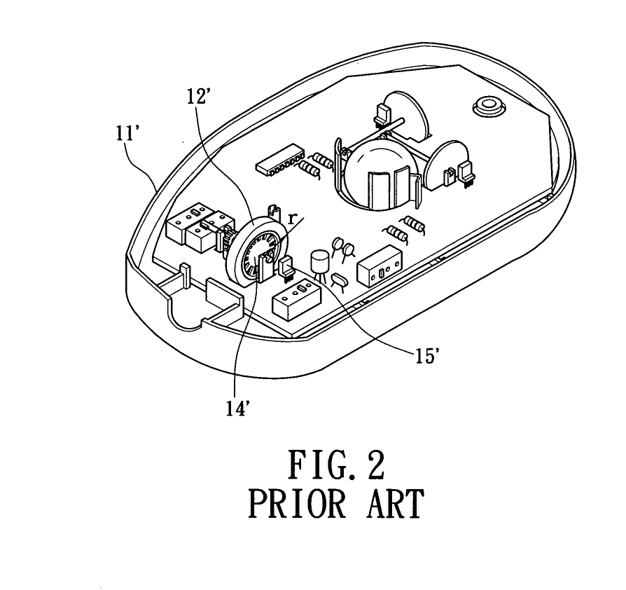

### DETAILED DESCRIPTION OF THE PREFERRED EMBODIMENTS

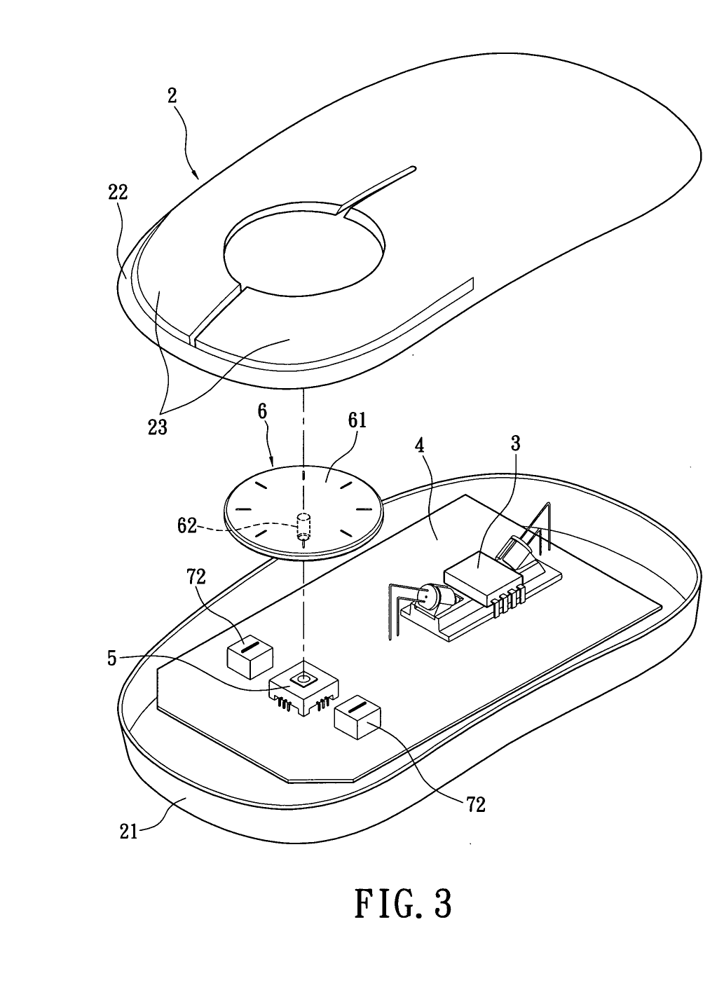

Referring to FIG. 3, the present invention provides a mouse structure for generating encoding signals, including: a main body 2, a cursor control unit 3, a printed circuit board (PCB) 4, a signal encoder 5 and a turntable unit 6.

The main body 2 is a hollow casing that is made of plastic material, and the main body 2 is composed of a bottom seat 21 and a top cover 22. The PCB 4 is disposed in the main body 2. The top cover 22 of the main body 2 has two key portions 23 formed on a front side of a top surface thereof. Two pressing switches 72 are electrically disposed on the PCB 4 and respectively correspond to the two key portions 23. The two key portions 23 are pressed by user to respectively operate the two pressing switches 72, so that a computer can be operated by pressing the two key portions 23.

The cursor control unit 3 can be a mechanical or optical control unit. Because a usage space on a bottom portion of the main body 2 can be decreased, the optical control unit is perfect in the present invention. The cursor control unit 3 is disposed in the main body 2 and is electrically disposed on the PCB 4. The cursor control unit 3 is exposed by the bottom seat 21 of the main body 2 in order to control direction and position of a cursor on a monitor of the computer

The signal encoder 5 can be a mechanical or optical encoder. The signal encoder 5 is disposed in the main body 2 and is electrically disposed on the PCB 4. In the present invention, the signal encoder 5 is a mechanical encoder.

Referring to FIG. 3, the turntable unit 6 has a turntable 61 and a movable body 62 extended downwards from a bottom surface of the turntable 61. The movable body 62 is a cylinder. The turntable unit 6 is exposed by the top cover 22, so that the turntable unit 6 can be rotatably disposed on a front side of a top portion of the main body 2. The movable body 61 is projected into the main body 2 and passes through the signal encoder 5.

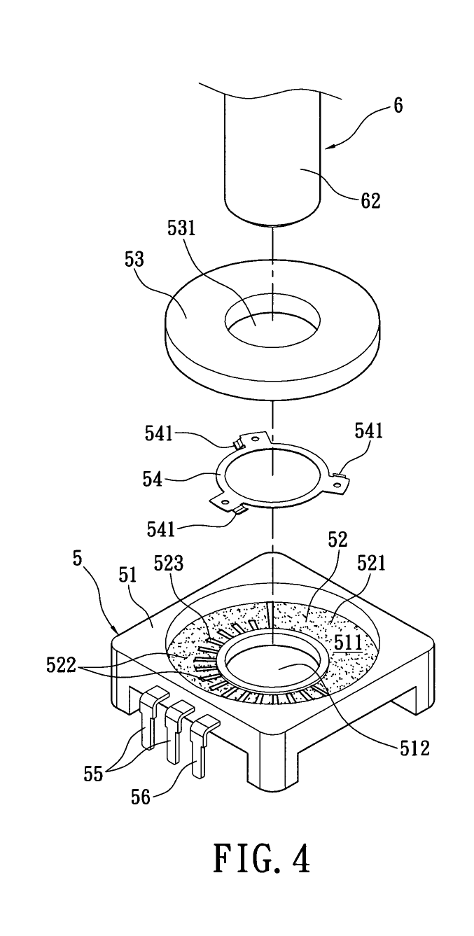

Referring to FIG. 4, the signal encoder 5 has an insulative seat 5, an annular electrode 52, a turntable element 53, a conductive piece 54, two signal terminals 55 and a common terminal 56.

The insulative seat 5 has an annular portion 511 concaved and disposed on a center position thereof and a through hole 512 passing therethrough. The annular electrode 52 is disposed in the annular portion 511. The annular electrode 52 has a common electrode 521, two encoding electrodes 522, and a plurality of insulative areas 523 separated from each other and formed on the common electrode 521 and the two encoding electrode 522. The two signal terminals 55 and the common terminal 56 are extended and bent from one side of the insulative seat 51. The two encode electrodes 522 are electrically connected to the two signal terminals 55, respectively. The common terminal 56 is electrically connected to the common electrode 521. The two signal terminals 55 and the common terminal 56 are electrically connected to the PCB 4.

The conductive piece 54 is an annular conductor and has three conductive claws 541 extended and bent therefrom. The turntable element 53 has a penetrating hole 531 passing through a center portion thereof. The conductive piece 54 is fixed on a bottom side of the turntable element 53. The turntable element 53 is rotatably disposed in the annular portion 511 of the insulative seat 51, so that the penetrating hole 531 corresponds to the through hole 521 and the conductive piece 54 is driven to rotate in order to electrically contact the conductive claws 541 of the conductive piece 54 with the annular electrode 52. The movable body 62 of the turntable unit 6 passes through the penetrating hole 531 of the turntable element 53 and is extended outside the through hole 512 of the insulative seat 51 in order to drive the turntable element 53 to rotate, so that the conductive claws 541 is rotatably contacted with the annular electrode 52 in order to generate encoding signals to scroll screen on the monitor of the computer.

When the turntable element 53 is rotated by rotating the turntable 61 in order to rotate the conductive piece 54, the three claws 514 respectively contact with one encoding electrode 522, the common electrode 521 and one insulative area 523 in order to generate encoding signals.

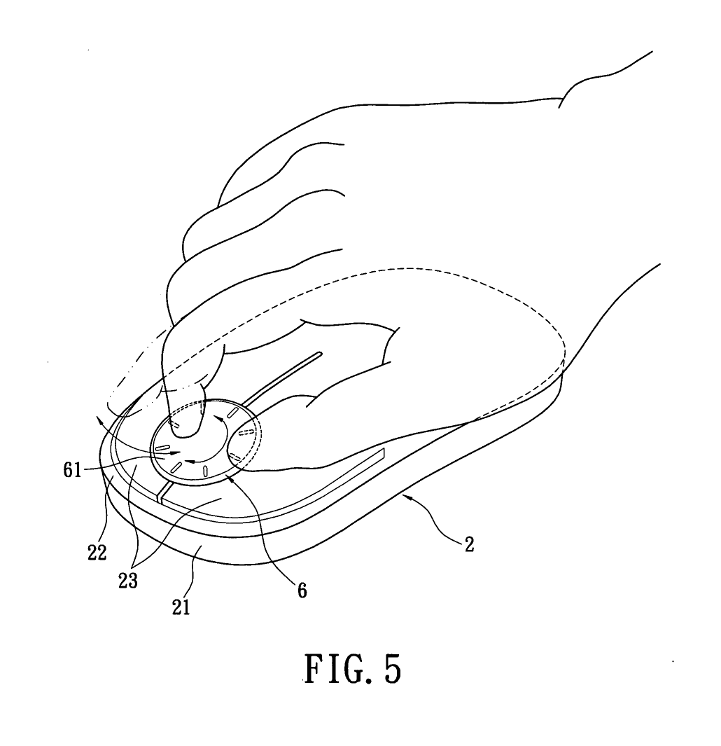

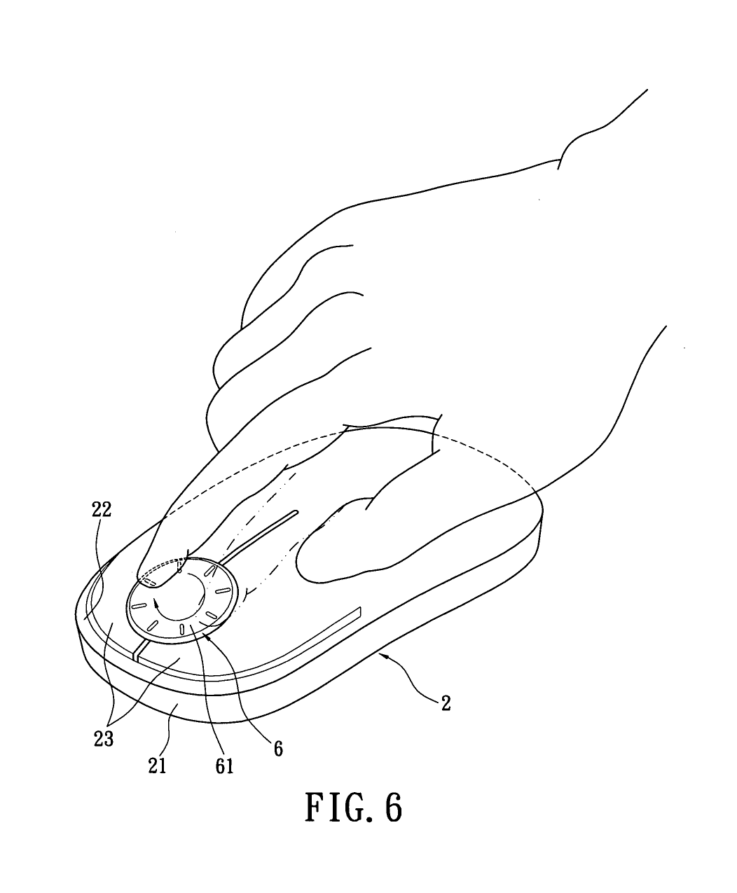

The present invention provides two operation ways for user, as follows: (1) referring to FIG. 5, the finger of the user can slide upwards or downwards on the edge of the turntable 61 in order to generate encoding signals; (2) referring to FIG. 6, the finger of the user can rotatably move on the edge of the turntable 61 in order to generate encoding signals.

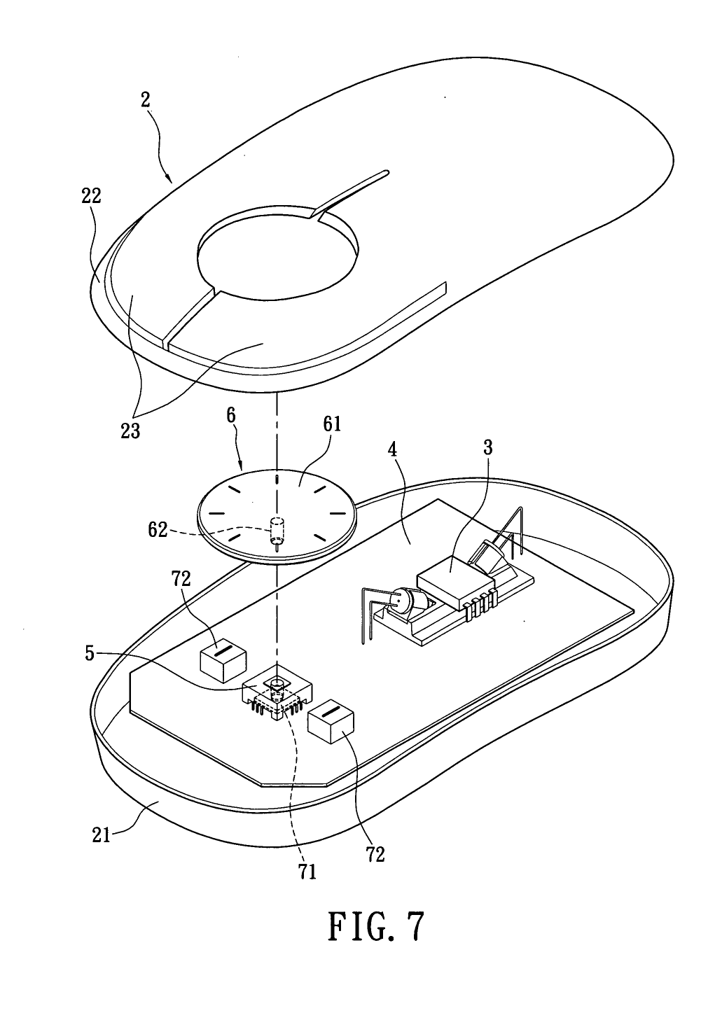

Referring to FIG. 7, the present invention further includes a mechanical touching switch 71 disposed in the main body 2 and electrically connected to the PCB 4. The touching switch 71 is disposed under the signal encoder 5 and corresponds to the movable body 62 of the turntable unit 6, so that the turntable 61 can be moved upwards and downwards. Therefore, when the turntable unit 6 is moved downwards, the touching switch 71 is pressed by the movable body 62 in order to continuously scroll screen on the monitor of the computer or in order to confirm a command of the computer (but that does not limit the present invention). In other aspect, the present invention can arrange more than one touching switches 71 under the signal encoder 5 and the turntable 61. When the turntable 61 is pressed downwards, one of the touching switches 71 is pressed to execute action.

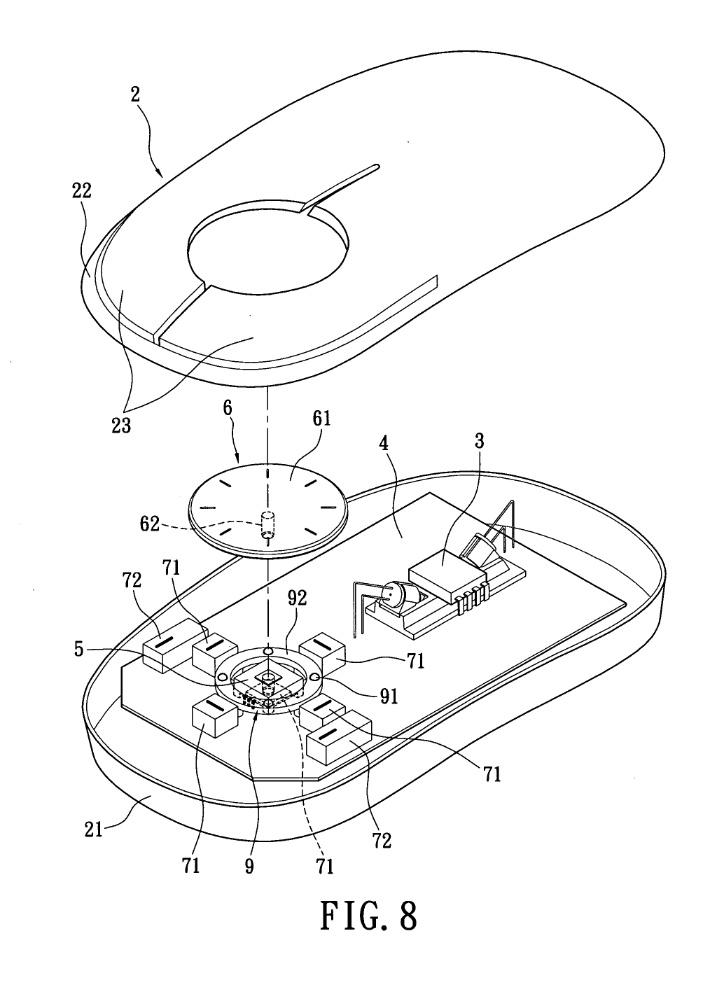

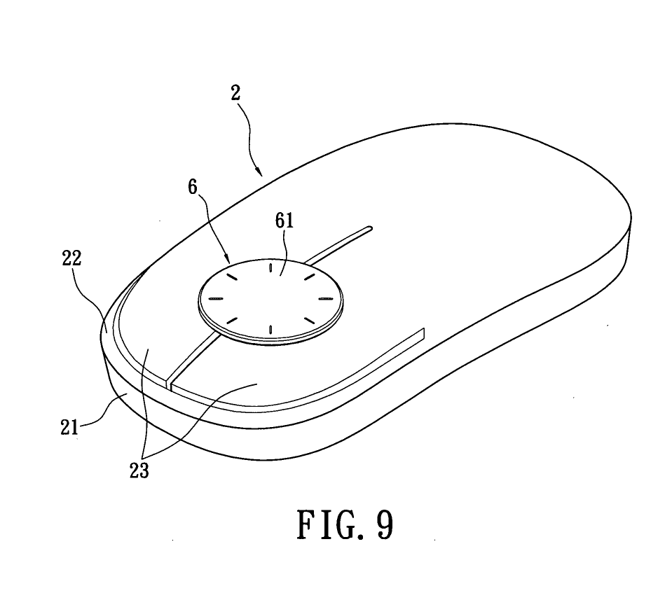

Referring to FIGS. 8 and 9, the difference between the second embodiment and the first embodiment is that: the second embodiment includes a plurality of touching switches 71 and a ball-positioning device 9. The main body 2 has two key portions 23 formed on a front side of a top surface thereof. Two of the touching switches 71 are correspondingly disposed under the two key portions 23.

The number of the touching switches 71 can be three or four. The second embodiment provides four touching switches 71 disposed in the main body 2 and electrically connected to the PCB 4. The touching switches 71 are disposed around the PBC 4 and are separated from each other by the same interval. The touching switches 71 are disposed under the turntable 61. When the turntable 61 is pressed downwards, the turntable 61 can touch any one of the touching switches 71. The ball-positioning device 9 is disposed in the main body 2 and has a plurality of balls 91 touching the bottom side of the turntable 61. The balls 91 and the turntable 61 are moved synchronously.

The ball-positioning device 9 has a fixing seat 92, and the balls 91 are disposed on the fixing seat 92. The fixing seat 92 is disposed in the main body 2 and between the touching switches 71. The movable body 62 of the turntable unit 6 passes through the fixing seat 92.

The signal encoder 5 can be driven by the turntable 61 to generate encoding signals in order to scroll the screen on the monitor of the computer. When turntable 61 presses the touching switch 71, the screen on the monitor of the computer can be scrolled continuously. When the turntable 61 is rotated by a large force, the balls 91 of the ball-positioning device 9 can prevent the turntable 61 from inclining and prevent the touching switches 71 from being touched.

Moreover, there is another touching switch 71 disposed under the signal encoder 5 and corresponding to the movable body 62 of the turntable unit 6, so that the turntable 61 can be applied to control many functions.

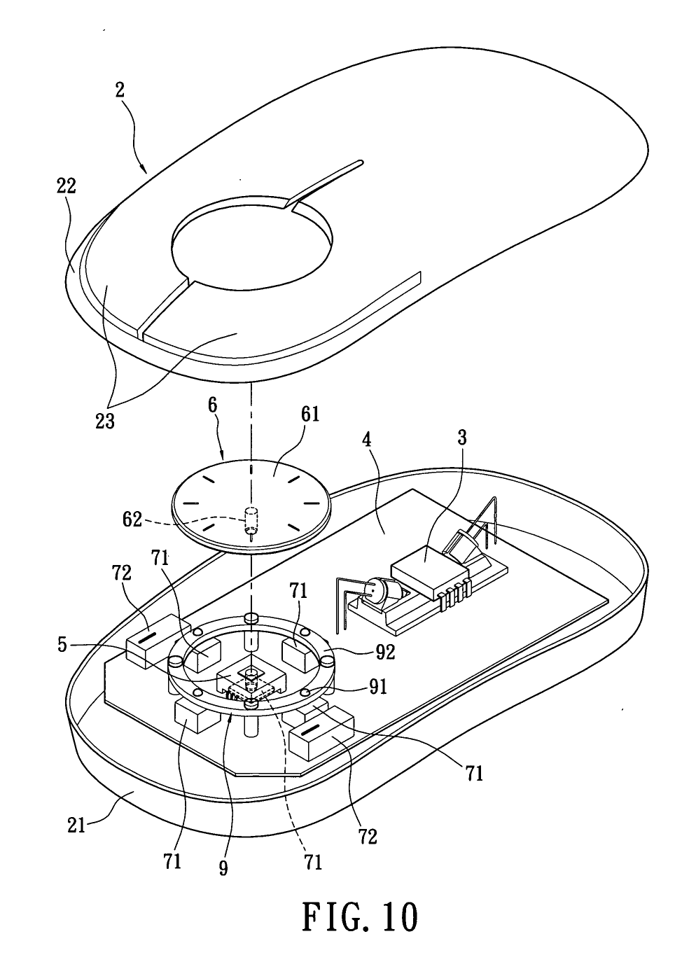

Referring to FIG. 10, the balls 91 of the ball-positioning device 9 are disposed above the touching switches 71. When the turntable 61 is pressed downwards, the balls 91 are moved downwards to touch the touching switches 71 to generate predetermined actions.

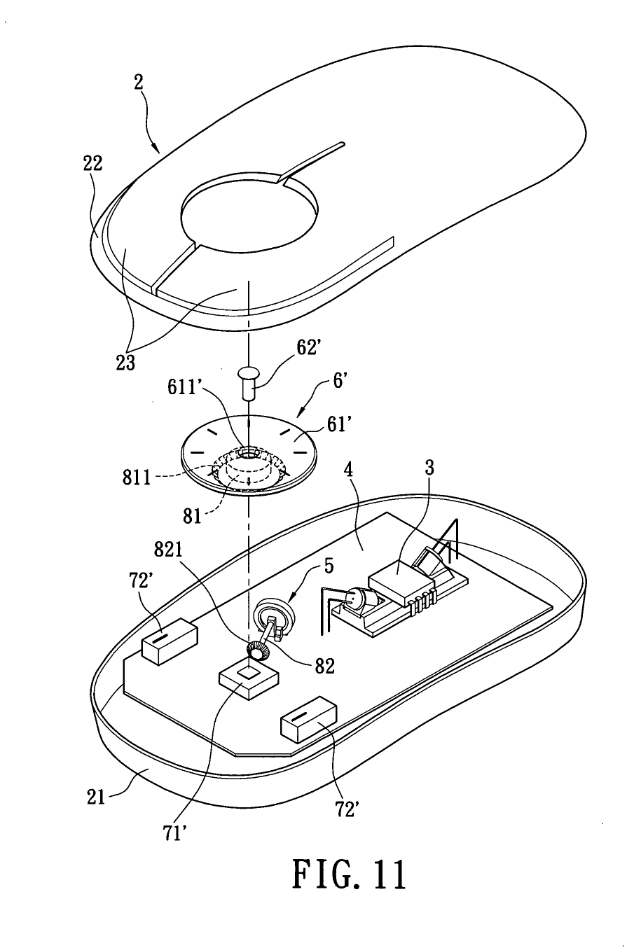

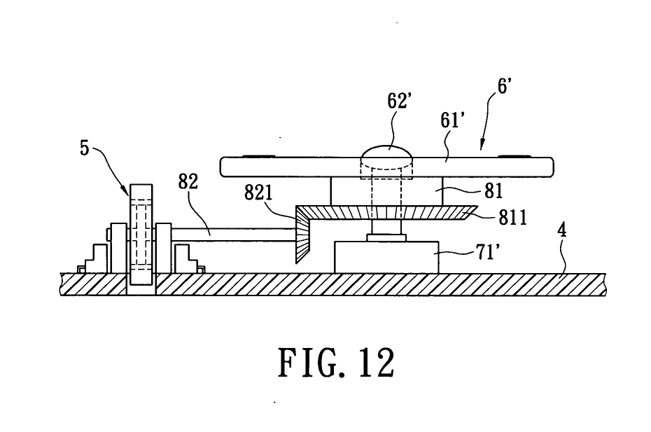

Referring to FIGS. 11 and 12, the third embodiment has a linkage mechanism 81 and a driven mechanism 82.

The turntable 61′ of the turntable unit 6′ has an opening 611′ passing through a center portion thereof. The movable body 62′ also is a cylinder, but that does not limit the present invention. The movable body 62′ passes through the opening 611′ of the turntable 61′ and is movably extended into the inner portion of the main body 2. There is a touching switch 71′ disposed in the main body 2 and electrically connected to the PCB 4. The touching switch 71′ corresponds to an end portion of the movable body 62′, so that the touching switch 71′ can be touched by the movable body 62′ in order to generate predetermined actions. There are two pressing switches 72′. The signal encoder 5 is vertically and electrically disposed on the PCB 4. The signal encoder 5 is an optical encoder in FIG. 11.

The linkage mechanism 81 is disposed in the main body 2 and connects to the turntable 61′. The linkage mechanism 81 can be rotated by rotating the turntable 61′. In the present invention, the linkage mechanism 81 is integratedly and vertically disposed on the bottom side of the turntable 61′, but that does not limit the present invention. The linkage mechanism 81 has a first gear portion 811 disposed on an end thereof. The first gear portion 811 can be a bevel gear or a spur gear. The end of the movable body 62′ passes through the linkage mechanism 81 and is extended outside the linkage mechanism 81.

The driven mechanism 82 is pivotally disposed in the main body 2. The driven mechanism 82 can be driven by rotating the linkage mechanism 81. In the present invention, the driven mechanism 82 is rotatable and is obliquely or horizontally disposed in the main body 2. The driven mechanism 82 has a second gear portion 821 disposed on a front side thereof. The second gear portion 821 is correspondingly engaged with the first gear portion 811. The end of the driven mechanism 82 passes through the signal encoder 5 in order to drive the signal encoder 5 to generate encoding signals that are used to control the movement of the screen on the monitor of the computer.

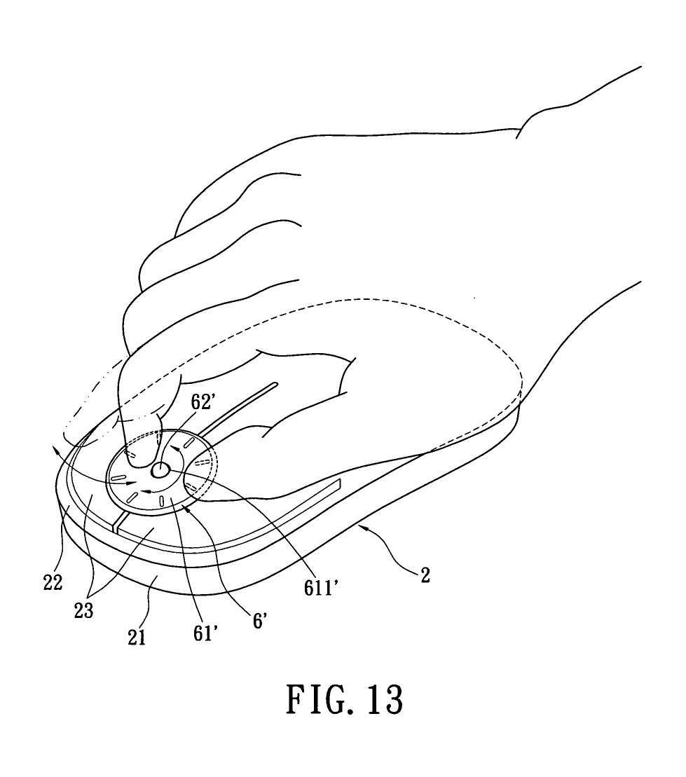

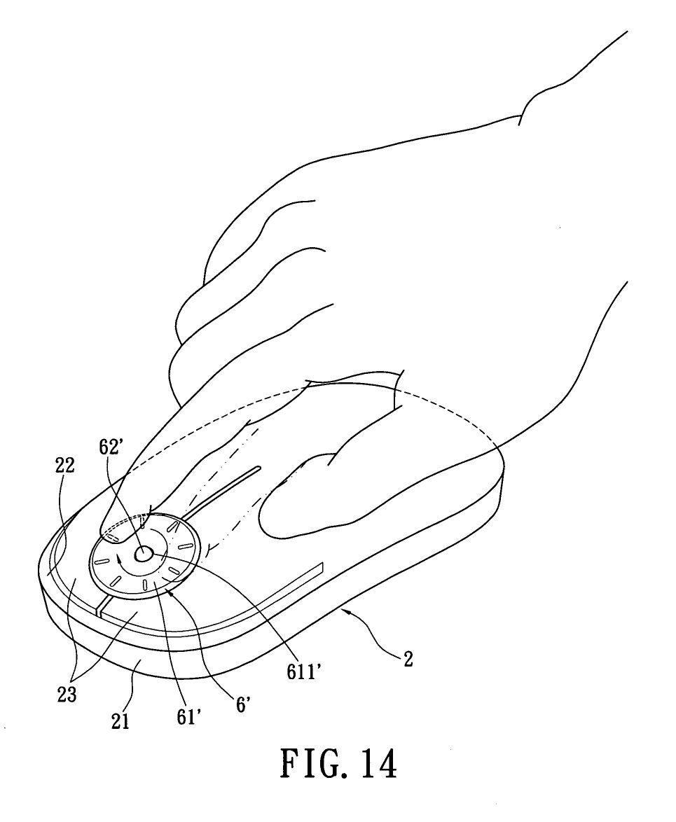

This embodiment also provides two operation ways for user, as follows: (1) referring to FIG. 13, the finger of the user can slide upwards or downwards on the edge of the turntable 61′ in order to drive the linkage mechanism 81 to rotate the driven mechanism 82 for generating encoding signals; (2) referring to FIG. 14, the finger of the user can rotatably move on the edge of the turntable 61′ in order to generate encoding signals.

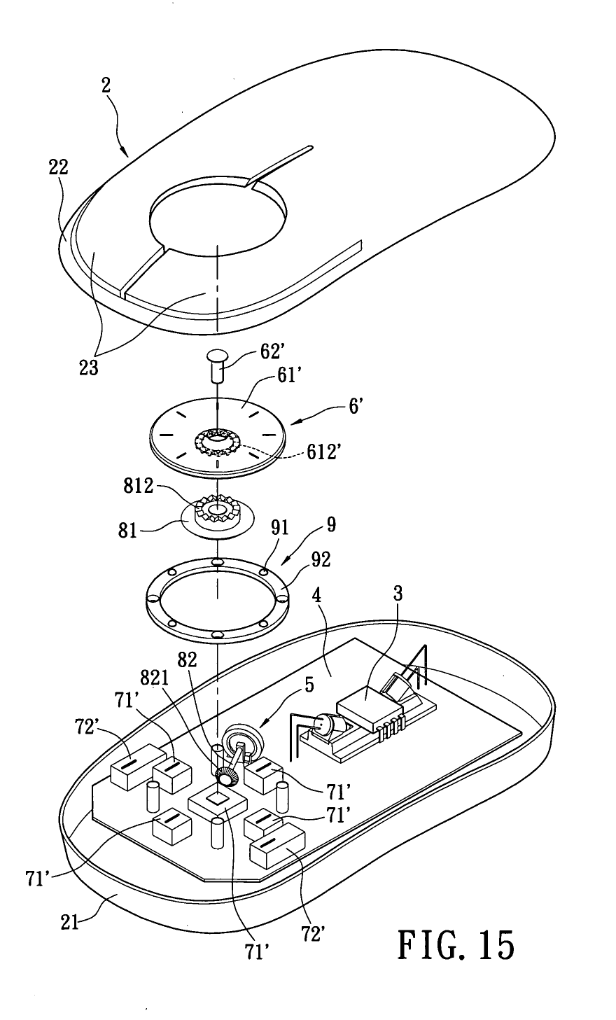

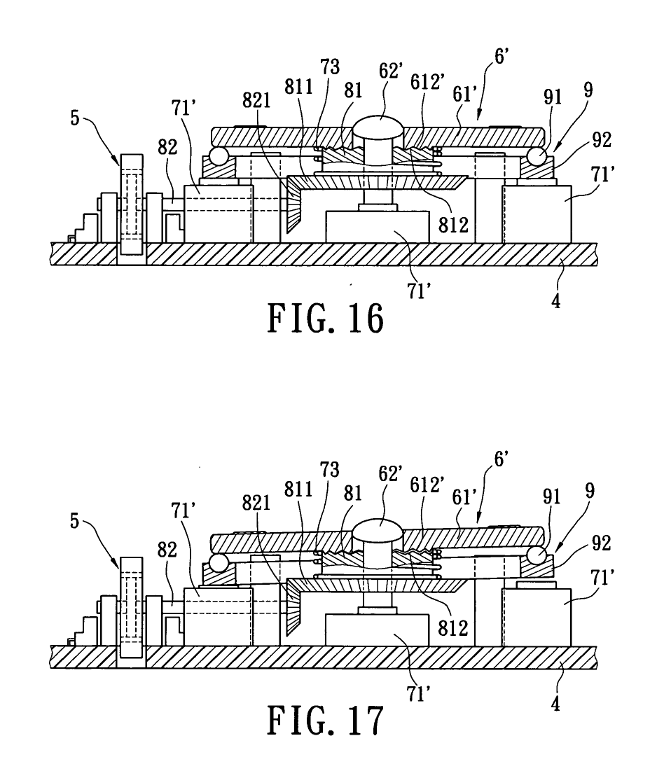

Referring to FIGS. 15 to 17, the fourth embodiment provides a plurality of touching switches 71′ and a ball-positioning device 9. The number of the touching switches 71′ is four, and the four touching switches 71′ are disposed in the main body 2 and electrically connected to the PCB 4. The touching switches 71′ are annularly disposed on the PCB 4 and are separated from each other by a predetermined interval. The touching switches 71′ are disposed under the edge portion of the turntable 61′ of the turntable unit 6′.

The turntable 61′ can be longitudinally and movably disposed in the main body 2. Any one of the touching switches 71′ is driven by pressing the edge portion of the turntable 61′. The turntable 61′ has a gear portion 612′ disposed on a bottom side thereof, and the linkage mechanism 81 has a gear portion 812 disposed on a top side thereof and engaged with the gear portion 612′. Hence, the turntable 61′ and the linkage mechanism 81 are rotated simultaneously. There is an elastic element 73 disposed between the turntable 61′ and the linkage mechanism 81, and the elastic element 73 can be an elastic piece or spring. The elastic element 73 abuts against the bottom portion of the turntable 61′, so that the turntable 61′ can be moved upwards or downwards in order to engage the two gears 612′, 812 with each other or separate the two gears 612′, 812 from each other. In addition, referring to FIG. 15, the four touching switches 71′ under the turntable 61′ occupy many space on the PCB 4, so that the driven mechanism 82 is horizontally and obliquely disposed on the PCB 4 to contact with the linkage mechanism 81.

The ball-positioning device 9 is also disposed in the main body 2. The ball-positioning device 9 has a plurality of balls 91 and a fixing seat 92, and the balls 91 are disposed on the fixing seat 92. The balls 91 of the ball-positioning device 9 contact with the bottom side of the turntable 61′ of the turntable unit 6′, and the balls 91 and the turntable 61′ are moved together. There is another touching switch 71′ correspondingly disposed under the end side of the movable body 62′ of the turntable unit 6. The operation is the same as the second embodiment.

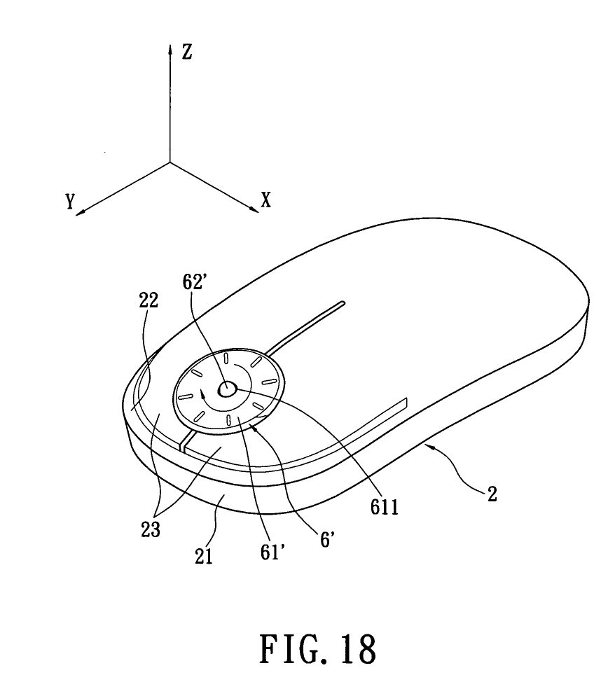

Moreover, referring to FIG. 18, in the third and fourth embodiments, the action direction of the movable body 62′ of the turntable unit 6 is various. In the present invention, the movable body 62′ can be pressed leftwards and rightwards along an x-axis, the movable body 62′ can be pressed forwards and backwards along a y-axis, and the movable body 62′ can be pressed downwards along a z-axis, so that the movable body 62′ has five pressing effects. Each touching switch 71′ has a different function corresponding to the movement of the movable body 62′. Hence, the usage function of the movable body 62′ is increased.

In conclusion, the turntable is transversely disposed on the main body, so that the user can control the scrolling of the screen on the monitor of the computer by rotating the turntable. In addition, the turntable is transversely disposed on the main body, so that the vertical space of the main body is reduced in order to reduce the size of the mouse.

The present invention provides two ways to control the scrolling of the screen on the monitor of the computer. According to ergonomics, various operation ways can prevent the joint of the forefinger from injuring easily due to continual reciprocating action.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A mouse structure for generating encoding signals, comprising:
a main body having a PCB disposed therein;
a turntable unit having a turntable and a movable body connected to the turntable, the turntable unit rotatably disposed on the main body, and the movable body projected into the main body; and
a signal encoder disposed in the main body and corresponding to the turntable, wherein the signal encoder is electrically connected with the PCB, and the movable body passes through the signal encoder.

2. The mouse structure according to claim 1, wherein the signal encoder is a mechanical or optical encoder.

3. The mouse structure according to claim 1, wherein the top cover of the main body has two key portions formed thereon, and two pressing switches are electrically disposed on the PCB and respectively correspond to the two key portions.

4. The mouse structure according to claim 1, further comprising a touching switch disposed in the main body and under the signal encoder, wherein the touching switch is electrically connected to the PCB and corresponds to the movable body of the turntable unit, and the turntable is vertically and movably disposed on the main body.

5. The mouse structure according to claim 1, further comprising more than one touching switches disposed in the main body and under the signal encoder, wherein the touching switches are electrically connected to the PCB and corresponds to the turntable of the turntable unit, and the turntable is vertically and movably disposed on the main body in order to touch one of the touching switches.

6. The mouse structure according to claim 1, further comprising a ball-positioning device disposed in the main body, wherein the ball-positioning device has a plurality of balls touching the bottom side of the turntable.

7. The mouse structure according to claim 6, wherein the ball-positioning device has a fixing seat, the balls are disposed on the fixing seat, and the fixing seat is disposed in the main body.

8. The mouse structure according to claim 1, further comprising another touching switch disposed under the signal encoder, electrically connected to the PCB and corresponding to the movable body of the turntable unit, wherein the turntable is vertically and movably disposed on the main body.

9. A mouse structure for generating encoding signals, comprising:
a main body having a PCB disposed therein;
a turntable unit having a turntable and a movable body, the turntable unit rotatably disposed on the main body, the turntable having an opening, and the movable body passing through the opening and movably extended into an inner portion of the main body;
a linkage mechanism disposed in the main body and connected to the turntable, and the linkage mechanism being rotated by rotating the turntable;
a driven mechanism pivotally disposed in the main body and contacted with the linkage mechanism; and
a signal encoder disposed in the main body and electrically connected with the PCB, wherein the driven mechanism passes through the signal encoder in order to drive the signal encoder.

10. The mouse structure according to claim 9, wherein the signal encoder is a mechanical or optical encoder.

11. The mouse structure according to claim 9, wherein the linkage mechanism has a first gear portion disposed on an end thereof, the driven mechanism has a second gear portion disposed on a front side thereof and correspondingly engaged with the first gear portion, and the end of the driven mechanism passes through the signal encoder.

12. The mouse structure according to claim 9, wherein the main body has two key portions formed on a top surface thereof, and two touching switches correspondingly disposed under the two key portions.

13. The mouse structure according to claim 9, further comprising a touching switch disposed in the main body and electrically connected to the PCB, and the touching switch corresponds to an end portion of the movable body.

14. The mouse structure according to claim 9, further comprising:
a plurality of touching switches disposed in the main body and electrically connected to the PCB, and the touching switches disposed under the edge portion of the turntable; and
a ball-positioning device disposed in the main body and having a plurality of balls contacted with a bottom side of the turntable.

15. The mouse structure according to claim 14, wherein the ball-positioning device has a fixing seat, and the balls are disposed on the fixing seat.

16. The mouse structure according to claim 14, further comprising an elastic element disposed between the turntable and the linkage mechanism, and the elastic element abuts against a bottom portion of the turntable, so that the turntable is moved upwards or downwards.

17. The mouse structure according to claim 14, further comprising another touching switch correspondingly disposed under an end side of the movable body and electrically connected to the PCB.
